(19) United States
(12) Patent Application Publication
(10) Pub. No.: US 2004/0081845 A1
(43) Pub. Date: Apr. 29, 2004

(54) Prize medallion structure

(76) Inventor: Tsang-Tse Liao, Taipei (TW)

Correspondence Address: TROXELL LAW OFFICE PLLC, SUITE 1404, 5205 LEESBURG PIKE, FALLS CHURCH, VA, 22041, US

(21) Appl. No.: 10/279,998

(22) Filed: Oct. 25, 2002

(51) Int. Cl. B44C 1/00

(52) U.S. Cl. 428/524; 428/28

(57) ABSTRACT

A prize medallion structure, the structure consisting of a base having a minimum of one setting recess with a figured object of a matching profile nested in the setting recess. The figured object and the setting recess each have an interlocking coupling component and, furthermore, the respective mating surfaces of the figured object and the setting recess are irregular but superimpossable. During utilization, the figured object is endowed with different colors by electroplating, while the interlocking of the coupling components of the setting recess and the figured object as well as the frictional contact between their irregular mating surfaces keep the figured object mounted on the base. As such, the invention herein is not limited to a single color as is the case with prior art prize medals, but enables greater variation by increasing the possible range of different color combinations.

### BACKGROUND OF THE INVENTION

1) Field of the Invention

The invention herein relates to emblems bestowed for achievement and excellence, specifically a prize medallion structure utilizing interlocking components such that figured objects can be individually endowed with differing color combinations to enable greater variations in prize medallion fabrication.

2) Description of the Prior Art

A conventional prize medal, trophy cup or award plaque, referring to FIG. 1, has a structure comprised of a base and a figured object disposed in relief on the said base, wherein the said figured object on the prize medal, trophy cup, or award plaque is symbolic of a meritorious act in a certain endeavor, which can include sports such as baseball, football, and track. However, since the figured object and the base are a unitary entity, and the figured object cannot be electroplated separately, a common electroplated color or metallic finish is applied over both the base and the figured object, thereby precluding the electroplating of the base and the figured object with distinguishing colors or metallic finishes as might be required or to highlight the figured object, which leads to plain and uninteresting results; furthermore, to apply different color or metallic finish combinations onto the figured object necessitates executing repeated electroplating tasks before the figured object is differentiated sufficiently to stand out, a procedure that is complex and, furthermore, troublesome and thus extremely impractical.

In view of the conventional prize medal structure, its plain and uninteresting results when utilized and, furthermore, complex fabrication procedures that are avoidable as well as other disadvantages, the applicant addressed the shortcomings and began effecting improvements to solve the drawbacks. In search of logical solutions, the applicant conducted extensive research and re-design that culminated in the successful development of the prize medallion structure of the invention herein.

### SUMMARY OF THE INVENTION

The primary objective of the invention herein is to provide a prize medallion structure consisting of a base having a minimum of one setting recess with a figured object of matching profile nested in the said setting recess and, furthermore, the figured object and the setting recess each have an interlocking coupling component such that during utilization, the figured object is treated with various colors or electroplated to different hues according to requirements or particular attributes and fixed by means of coupling components such that the figured object is firmly nested in the setting recess and thereby mounted on the base; as such, the invention herein is not limited to a single color as is the case with prior art prize medals, but enables greater variation by increasing the range of different color combinations.

Yet another objective of the invention herein is to provide a prize medallion structure in which the mating surfaces of the figured object and the setting recess are irregular such that when the figured object is nested in the setting recess, they are not only interlocked by means of their coupling components, the figured object is also maintained firmly in the setting recess due to the increased frictional contact between their irregular mating surfaces to the extent that the figured object does not dislodge.

To enable the examination committee a further understanding of how the present invention achieves said objectives as well as the technological means and other functional features involved, the brief description of the drawings below are followed by the detailed description of the invention herein.

### BRIEF DESCRIPTION OF THE DRAWINGS

FIG. 1 is an isometric drawing of a conventional structure.

FIG. 2 is an exploded drawing of the invention herein.

FIG. 3 is an isometric drawing of the invention herein when implemented.

FIG. 4 is a cross-sectional drawing of the invention herein when implemented, as viewed from the perspective of line A-A.

FIG. 4-A is a magnified cross-sectional drawing of the invention herein when implemented, as viewed from the perspective of line A-A.

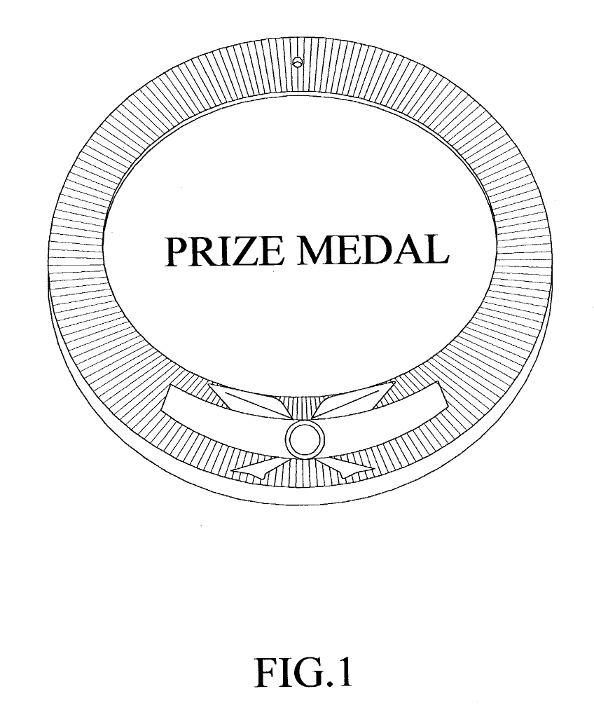

### DETAILED DESCRIPTION OF THE INVENTION

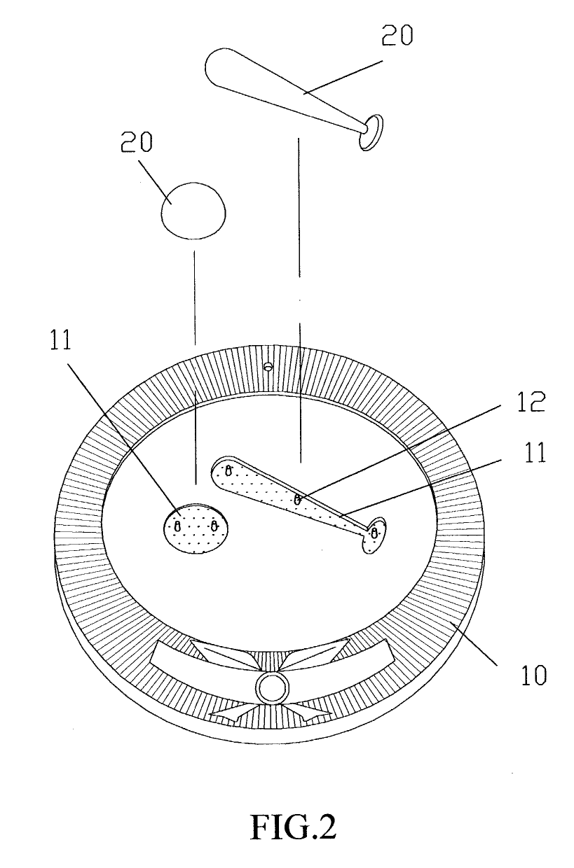

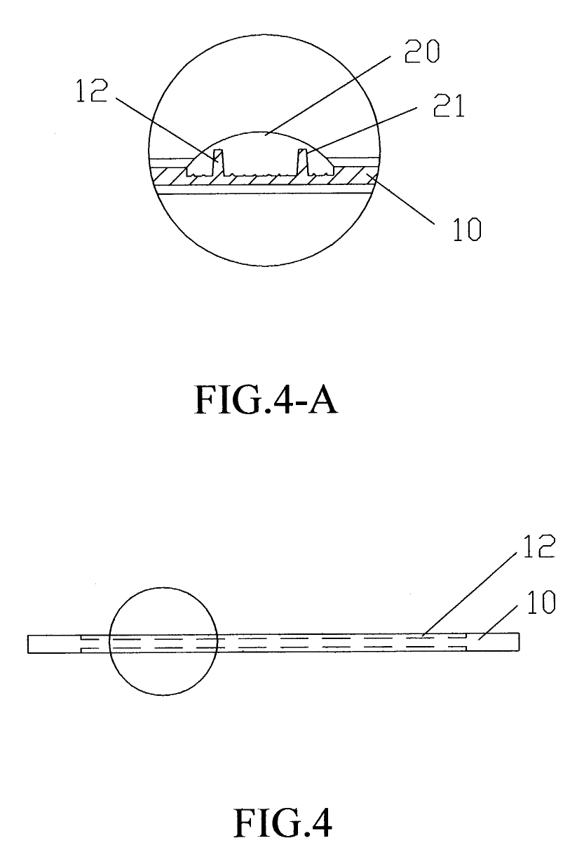

Referring to FIG. 2, the invention herein is a prize medallion structure; the said structure has a base 10 in its present embodiment, though persons skilled in the technology can substitute another item such as a trophy cup or award plaque, etc.; the diameter of the said base 10 does not exceed five centimeters and, furthermore, has a minimum of one setting recess 11 with a figured object 20 of matching profile nested in the said setting recess 11, the surface area of the said figured object 20 not exceeding two square centimeters; furthermore, the said figured object 20 and the setting recess 11 each have an interlocking coupling component 21 and 12, which in the embodiment herein consists of a mortise and a tenon, respectively; and, furthermore, the respective mating surfaces of the said figured object 20 and the setting recess 11 are irregular but superimpossable. (as shown in FIG. 4A).

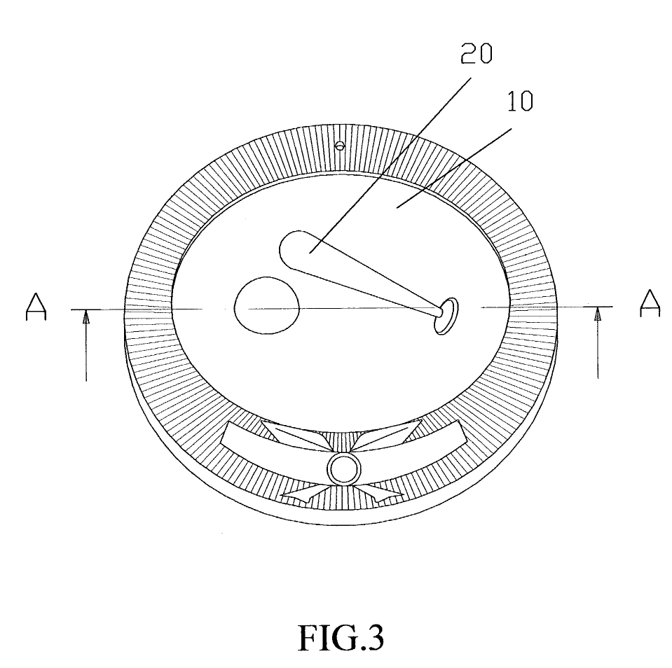

During utilization, referring to FIG. 2, FIG. 3, FIG. 4, and FIG. 4-A, the figured object 20 is treated with various colors or electroplated to different hues according to requirements or the particular attributes of the figured object 20, with the irregular mating surfaces of the figured object 20 and the setting recess 11 then placed flush against each other and fixed by means of their coupling components 21 and 12 such that the figured object 20 and the setting recess 11 are tightly conjoined to the extent that the figured object 20 thereby mounted on the base 10 does not dislodge (as shown in FIG. 3 and FIG. 4); as such, the invention herein differs from conventional prize medals that only have a single color and the overall prize medallion structure allows for greater variation and an even wider range of different color combinations.

In summation of the foregoing section, since the prize medallion structure of the present invention is of a straightforward structural arrangement, possesses utmost practicality, and increases consumer utilization willingness, the invention herein is an improvement over the drawbacks of prior art structures and affords greater functional utility.

Furthermore, the structure of the invention herein and its unique capability features were not observed in any other similar structure or device in public use or publication prior to patent application submission. Therefore, the applicant submits the present invention to the Patent Bureau for review and the granting of the commensurate patent rights.

The embodiments herein only serve to substantiate that the prize medallion structure of the invention is workable and, furthermore, all modifications thereof based on the above disclosure by persons skilled in the technology shall remain included within the spirit and claims of the invention herein.

1. A prize medallion structure comprised of:
a base, the said base having a diameter of less than five centimeters; the said base has a minimum of one setting recess and the mating surface of the said setting recess is irregular.
a figured object, having a profile matching that of the said setting recess, that is nested in the said setting recess; the surface area of the said figured object is less than two square centimeters and, furthermore, the respective mating surfaces of the said figured object and the said setting recess are irregular but superimpossable and the said figured object has a coupling component that interlocks to a coupling component in the said setting recess.
given the said structural arrangement, the said figured object can be endowed with different colors by electroplating, while the interlocking of the said coupling components as well as the frictional contact between the said irregular mating surfaces keep it mounted on the said base such that overall prize medallion structure supports numerous variations and assembly configurations.

2. A prize medallion structure as claimed in claim 1 in which the said interlocking components of the said figured object and the said setting recess respectively consist of a mortise and a tenon.
